(19) United States
(12) Patent Application Publication
(10) Pub. No.: US 2007/0045528 A1
(43) Pub. Date: Mar. 1, 2007

(54) Order charge separation and order-charge type separation

(76) Inventor: Richard John Ellis, Bordon (GB)

Correspondence Address: LAHIVE & COCKFIELD, LLP, ONE POST OFFICE SQUARE, BOSTON, MA, 02109-2127, US

(21) Appl. No.: 11/529,281

(22) Filed: Sep. 28, 2006

Related U.S. Application Data
(63) Continuation of application No. 10/915,105, filed on Aug. 9, 2004, now abandoned.
Application No. 10/915,105 is a continuation of application No. 09/486,403, filed on Oct. 19, 2000, now abandoned.

(51) Int. Cl. H01J 49/00

(52) U.S. Cl. 250/281

(57) ABSTRACT

Apparatus or a device for producing order charge and/or order-charged matter, and/or a source of the same and/or apparatus and/or techniques for extracting the same. A device and/or apparatus for separating and/or concentrating and/or purifying the said order charge and/or order-charged matter, either collectively (e.g. mixture of charge types), and/or as partially and/or completely separated and/or purified individual charge types. Apparatus and/or a device for collecting and/or containing the order charge and/or order-charged matter. Apparatus and/or a device for outputting and/or applying the order charge and/or order-charged matter. A complete system of these apparatuses and devices together with input and output interfaces which produce, and/or separate, and/or capture, and/or store, and/or process, and/or treat the order charge and/or order-charged matter.

### RELATED APPLICATIONS

The current application claims priority to U.S. Continuation application Ser. No. 10/915,105, filed on Aug. 9, 2004 from the following International Patent Application filed pursuant to Patent Cooperation Treaty (PCT) on Aug. 26, 1998, designating the United States. The International Patent Application is assigned International Application Number, PCT/GB98/02562 and names all the same inventors as this application: Ser. No. 09/486,403 ORDER CHARGE SEPARATION AND ORDER-CHARGE TYPE SEPARATION. The International Patent Application was published in English on Mar. 4, 1999, and assigned International Publication Number: WO 99/10895.

### TECHNICAL FIELD OF THE INVENTION

This invention relates to the charges of the Ordering Force, to separating and/or concentrating and/or purifying these charges, either collectively and/or individually, and to all the technologies which can subsequently be developed to use these order charges.

### BACKGROUND OF THE INVENTION

There are two parts to scientific research, there is research and there is experience. That is to say, there is academic research, and there is an approach where you know that you have got the right answer because you get the result you sought. The latter is a more practical, more pragmatic, perhaps less intellectual, perhaps more intuitive approach where by processes of pure invention and continuous experiment, things can be achieved that cannot be achieved by the more rational academic approach.

The academic approach is well known. It involves theory and experiment. It involves making hypotheses and testing them. Sometimes, in this way, discoveries are made. But sometimes they are not, or at least they are rejected. Einstein once said that theory tells you what you can think. Therefore, if something is contrary to the theory, your mind may be tempted to reject it. There are well known examples of this in physics. Parity violation was first observed in 1928, but it was rejected as an aberrant experimental effect because the theory of that time said that parity violation was impossible. Then T D Lee and Yang suggested that parity violation might be possible and Mme Wu rediscovered parity violation a few months later in 1956. It was she who won the Nobel prize, not those experimenters in 1928. Other examples can be easily found. Indirect evidence for the 3° K blackbody radiation was first found by E. McKellar in 1941. Independently, T. A. Shmaonov observed the blackbody radiation directly and published the result in his thesis in 1957. However, neither of these researchers won the Nobel prize because they could not explain what they had observed. Finally Penzias and Wilson observed it again for the third time and then had the good luck to bump into Dicke at Princeton, who explained that this was the after glow of the big bang, the relic radiation from Gamow's hot theory of the creation of the Universe. As a result, Gamow's theory was proven and Penzias and Wilson later won the Nobel prize.

My research has led me, over a forty year period, to conclude that there is a third long-range force in Nature, in addition to electromagnetism and gravitation, and I have found extensive evidence for this hidden away in the scientific literature. To my knowledge, few people or nobody expect this force to exist. My research shows that it creates order, that it reverses the second law of thermodynamics in animate and inanimate matter. So I call this force the “Ordering Force”.

### SUMMARY OF THE INVENTION

The illustrative embodiment of the present invention provides an apparatus for producing order charge.

In one aspect of the present invention, an order charge separation apparatus is disclosed. The order charge separation apparatus includes, in series, a source of order charge, means for selection on the basis of order charge, and a collection means for order charge. The order charge output system including the collection means, thereby can effectuate order-charge type separation. The order charge separation apparatus can further include a plurality of selection means operating as a cascade. The selection means is adaptable to operate in a manner other than by the ordering charge and the selection means can be based upon the order charge. Further, the selection means can include a high resolution mass spectrometer.

The order charge separation apparatus can further include a number of additional features including least one of ionization equipment, output interfaces, vacuum systems, optics, slits, baffles, and supporting equipment, arranged to assist in at least one of separate order charged matter from order-neutral matter, separate one order-charge type from another, and purify one order-charge type from another, until one or more order charge types have been separated from each other and purified.

In one aspect of the present invention, the source of the order charge separation apparatus includes a source of ionizing radiation. In another aspect of the present invention, the source of the order charge separation apparatus includes an alpha emitter. In a further aspect of the present invention, the source of the order charge separation apparatus includes a form of matter, at least part of which carries the order charge. The matter is helium from a reactor.

In still a further aspect of the present invention, the source of the order charge separation apparatus includes a radiation-emitting device which produces order-charged matter so as to produce a supply of order charged matter, the order charged matter being supplied to the order-charge separation apparatus as its source of order-charged matter. The radiation-emitting device can include a nuclear reactor or accelerator.

In a further aspect of the present invention, the source of the order charge separation apparatus includes one of a radioactive halo, rock, crystal, and other material which contains order charge. Yet still, the source of the order charge separation apparatus includes one of a particle accelerator, nuclear accelerator, heavy ion accelerator, storage ring, and colliding beam machine, which by processes of particle interactions causes nuclei to fragment into fragments, at least some of which are order-charged. In one aspect of the present invention, the fragments produced are subjected to one or more of means for mass selection, momentum selection, direction selection, cooling, deceleration, acceleration, focusing into a beam, and ionization. In another aspect of the present invention, the fragments are subjected to at least one of means for passing the fragments through an input interface, ionizing the fragments, converting the fragments into a beam, focusing the fragments, concentrating the fragments, deflecting the fragments, decelerating the fragments, and accelerating the fragments.

In one aspect of the present invention, the source of order charge of the order charge separation apparatus includes free order charge which has subsequently been attached to matter. The free order charge is attachable by exposure to sunlight.

In another aspect of the present invention, the source of order charge of the order charge separation apparatus generates radiation that is subjected to at least one of means for passing the radiation through an input interface, separating the radiation, collecting the radiation, concentrating the radiation, and ionizing the radiation. The radiation is focusable into a beam which is subjected to at least one of means for concentrating the beam, deflecting the beam, decelerating the beam, degrading the beam, and accelerating the beam.

In a further aspect of the present invention, the order-charged matter is subjected to at least one of means for passing the matter through an input interface, ionizing the matter, and wherein the matter is focused into a beam which is subjected to at least one of means for concentrating the beam, deflecting the beam, decelerating the beam, and accelerating the beam. In another aspect of the present invention, the order-charged matters are subjectable to at least one of means for passing the matter through an input interface, ionizing the matter, converting the matter into a beam, focusing the matter, concentrating the matter, deflecting the matter, decelerating the matter, and accelerating the matter.

In another aspect of the present invention, the order charge separation apparatus further includes a plurality of sources or order charge arranged for use individually and for use simultaneously. The order charge separation apparatus can further include means for switching from one source to another.

In one aspect of the present invention, the order charge separation apparatus further includes preparation means for preparing at least partially order-charged matter prior to introduction to the collection means. In one aspect of the present invention, the at least partially order-charged matter is introduced into one of the means for selection and the collection means of the order charge separation apparatus.

In another aspect of the present invention, the order charge separation apparatus further includes means for passing at least partially order-charged matter through a separator so as to separate order-charged from order-neutral states. In a further aspect of the present invention, the separator of the apparatus includes at least one of a mass spectrometer, a mass spectrometer-type apparatus, an accelerator-type mass-spectrometer, an accelerator, a cyclotron, a cyclotron-type device, a storage ring, a Penning trap, and a Smith-type spectrometer. The separator can achieve separation of different mass states corresponding to different order-charge states by one or more of electric fields, magnetic fields, time-of-flight, and slits. Further, the separator can be based upon range, so that a predetermined amount of matter is used to separate order-charge or order-charged states respectively at the expense of order-neutral states. In another aspect of the present invention, the separator is a combination of range and a mass spectrometer so that partial separation is brought about by range, and partial separation is brought about by the mass spectrometer. In a further aspect of the present invention, the separator is a type of spectrometer with one of an electric and magnetic field together with one of a velocity detector, velocity selector, time-of-flight device and energy loss device, which can separate different mass states. Further, the separator can be based on a type of process which is one of mass sensitive, sensitive to nuclear magnetic moments, otherwise sensitive to order charge. Moreover, the separator can include one of a spectrometer, diffraction, resonance process, kinematic process, range, diffusion, and chemical reaction, which can be used to separate order-charged matter from order-neutral matter. In one aspect of the present invention, the thickness of material traversed is sufficient to at least partially separate order-charge from order-neutral states.

In another aspect of the present invention, the separator is an order-charge separator having an active element, the active element being order-charge or an order-charge field, so that order-charge states passing through the separator are deflected by the order-charge or order field, respectively, whilst order-neutral states remain undeflected.

In a further aspect of the present invention, the order charge separation apparatus further includes a range attenuation element formed as part of an input interface to reduce the energy of the input particles either to no more than those that match a mass spectrometer, as part of an input interface which subsequently processes the order-charged states by one of acceleration and focusing so as to match input energy and phase space of the mass spectrometer and maximize the flux therethrough.

In a further aspect of the present invention, the order charge separation apparatus further includes at least one of a restriction, limitation, cut, slit aperture, barrier and optics to separate order-charge states from order-neutral states. In another aspect of the present invention, the order charge separation apparatus further includes means for adjusting one of the restriction, limitation, cut, slit aperture, barrier and optics.

In a further aspect of the present invention, the order charge separation apparatus further includes first means for separating the order charge based on range, and a second means for separating the order-charge. In another aspect of the present invention the range separation is used as at least part of an input interface to a subsequent order-charge separation.

In another aspect of the present invention, the order charge separation apparatus further includes a triggerable device actuatable to separate a small group of order charged particles or states from order-neutral states. In one aspect of the present invention the triggerable device includes at least one of a mobile shutter, a pulsed field, an electric field, a magnetic field, a kicker magnet, a mechanical intervention device, an electronic device, an order-charged device, a time-of-flight system, a pulse height technique and an energy loss system.

In one aspect of the present invention, the order charge separation apparatus further includes means for concentrating the order charge by selecting those states which carry the order charge. In a further aspect of the present invention, the order charge separation apparatus further includes selection means for selecting order-charged matter on the basis of at least one of energy and directional properties as compared to those of order neutral matter. In another aspect of the present invention, the order separation apparatus further includes selection means for selecting order-charged fragments from one of a radioactive source and nuclear collisions on the basis of at least one of direction, velocity, momentum and particle-type differences.

In one aspect of the present invention, the order charge separation apparatus further includes an output interface leading to the collection means. In another aspect of the present invention, the order charge separation apparatus further includes a stopping device included in one of an output interface and the collection means. In a further aspect of the present invention, the order charge outputted by the source is in at least partial vacuum and is movable. In one aspect of the present invention, the stopping device is one of a Faraday cup, metal plate, solid material, liquid material, and gaseous material, constructed for stopping order-charged materials. In another aspect of the present invention, the stopping device absorbs order-charged materials for subsequent extraction. In a further aspect of the present invention, the stopping device comprises material which is removable after time spent absorbing order-charged material. The material includes a metal plate.

In still a further aspect of the present invention, the stopping device includes extractable fluid. In one aspect of the present invention, the order charge separation apparatus further includes means for circulating the fluid to facilitate extraction. In another aspect of the present invention, the stopping device is movable, and is arranged to first move to a separate area in a vacuum chamber where at least part of the stopping device is constructed to re-emit order charged matter. In one aspect of the present invention, the stopping device is a decelerating device, which enables the output from the separator to be collected. In one aspect of the present invention, the stopping device includes at least one of electric and electromagnetic field generation means.

In a further aspect of the present invention, the order charge separation apparatus further includes means for causing the stopping device to re-emit order charged matter, thereby to enable collection. In one aspect of the present invention, the re-emission is caused by heating.

In one aspect of the present invention, the order charge separation apparatus further includes an output system which provides one of an order-charge source, and an order-charge beam, which can be used as a beam of order charge. In one aspect of the present invention, the output system is in the form of an external beam arranged to pass through a window thereby to allow the order-charged matter to exit the system. In a further aspect of the present invention, the order charge separation apparatus further includes detection means associated with the output in order to facilitate at least one of measurement of the mass spectrum of the matter, determination of regions where ordered-charged states occur, adjustment of the system, operation of the system to select a state that carries a required order charge, separation of order-charged states from order-neutral states, adjustment of the system to optimize output, and monitoring of performance.

In one aspect of the present invention, the order charge separation apparatus further includes means operating on the separated order charge for generating an order field, and means employing the order field to further separate order-charged states from order-neutral states. In another aspect of the present invention, the order charge separation apparatus further includes means operating on the separated order charge for generating an order field, and means employing the order field to further separate order-charged states of different natures.

In one aspect of the present invention, previously separated order charge is shaped and used as a deflecting mechanism in an order charge spectrometer. In another aspect of the present invention, previously separated order charge is shaped and combined with at least one of electric and magnetic fields to assist in the means for selection. In a further aspect of the present invention, the amount of previously separated order charge is less than statistically required to achieve balance between order charges of different natures.

In one aspect of the present invention, the separated order charge is recycled at least once prior to output to selectively repel like-natured charges thereby to separate one order charge nature from another. In another aspect of the present invention, the separated order charge is recycled more than once. In a further aspect of the present invention, previously separated order charge is employed to selectively repel like natured order charge from a sample thereby to allow collection of an unlike natured order charge. In one aspect of the present invention, multiple natures of order charge are arranged to selectively repel respective natures of an incoming beam thereby to separate that beam into each of its constituent natures.

### BRIEF DESCRIPTION OF THE DRAWINGS

Embodiments of the present invention will now be described with reference to and/or as illustrated in the accompanying figures, in which;

FIG. 1 is a schematic illustration of an order charge separation apparatus suitable for practicing the illustrative embodiment of the present invention;

FIG. 2 is a schematic illustration of an order charge separation apparatus suitable for practicing the illustrative embodiment of the present invention that includes a source of heavy nuclei emitting alpha particles;

FIG. 3 is a schematic illustration depicting the principle of operation of a Smith-type spectrometer in accordance with the illustrative embodiment of the present invention;

FIG. 4 is a schematic illustration of a near-syandard mass spectrometer suitable for practicing the illustrative embodiment of the present invention;

FIG. 5 is a schematic illustration of an order-charge spectrometer, or secondary spectrometer suitable for practicing the illustrative embodiment of the present invention;

FIG. 6 is a schematic illustration an order charge separation apparatus, including individual charges, suitable for practicing the illustrative embodiment of the present invention.

### DETAILED DESCRIPTION

The Ordering Force has peculiar properties. It has multiple charges M and it has multiple vector bosons N. It is a non-Abelian force so that the vector bosons, which for convenience may be called “Orderons”, carry the order charge. As a result, the orderons are self-interacting. The orderons appear to be massless and so the force obeys an inverse-square law and is long-range. Therefore, the self-interacting orderons can form extensive networks.

The strength of the Ordering Force is about 6 times that of electromagnetism, depending on the energy, so that it is intermediate in strength between electromagnetism and the strong interaction. Present scientific technology cannot detect the order charge, nor can it detect orderons in the environment. Therefore, science is completely oblivious to the effects of this force. Nevertheless, its effects exist and sometimes these show up in scientific experiments, where they tend to remain as unexplained phenomena which are ignored. One of these strange effects is that the Ordering Force can transmute elements in both animate and inanimate matter. There are in fact hundreds of experiments which show this, yet they are little known, and either dismissed or ignored.

The way in which the Ordering Force can transmute elements is of interest, because it is unusual. There is evidence that it can transmute elements without producing any radioactive secondaries. In order to understand this, it is necessary to understand how it interacts with matter.

The Ordering Force does not interact with electrons, at least not directly, because it is not an electromagnetic force. Furthermore, it either does not interact with most nuclei which are order-neutral, or if it does interact with them, it does so indirectly. There are reasons to believe that most nuclei (on the earth) are “order-neutral”, that they are not charged with the order charge. As a result, the orderons cannot interact with them directly. However, there may be order charge within nuclei in which case they could interact with it by means of “order van der Waals forces”, i.e. by distorting the order charge and then interacting with the dipole, quadrupole or higher moment. It would appear that the orderons can form networks around nuclei in order to so distort them and then interact with them. However, such order van der Waals forces would in the main fall off rapidly with distance (normal van der Waals forces decrease as 1/r⁷), and so they could well be quite weak, which is why their effects are not usually noticed.

The view that we have then, is that there is a third long-range force which currently cannot be detected directly and so is unknown to science. Most matter is neutral with respect to this force and interacts with it weakly or not at all, even though in principle it is stronger than electromagnetism. The experimental evidence is that this force can create order (i.e. reverse the second law of thermodynamics) and transmute elements without producing any significant amounts of radiation. It would appear that both these properties are related to the tendency of this force to produce extended networks of relatively strongly interacting orderons.

There is evidence that the orderons become distributed throughout matter and then interact sufficiently strongly with it that they cannot separate from it so that the orderon network cannot collapse. It appears that there is a dynamical balance between the orderon network and its interactions with the surrounding matter. It is this tension between the two which enables the network to continue to exist and which enables it to act upon matter to create macroscopic ordered patterns.

The information presented here concerning the Ordering Force simply has to be taken at face value. The actual experimental facts which support its existence, which determine its properties, and the relationship of this discovery to known physics, is to be published elsewhere. It is more of academic interest and does not in anyway change the picture presented above, although the names used could be different. For the purposes of identification, experiment shows that the number of charges M of the Ordering Force is not 1, nor 2, nor 4, nor 8, but appears to be 3. There would presumably be the same number of anti-charges. The order-neutral state would thus require three different order charges, or an order charge and its anti-charge.

The Ordering Force, as a new force, has many potential uses. Some of these, perhaps many of them, would require, or benefit from, the separation of the order charges so that they subsequently may be controlled, processed, manipulated and so on in a wide range of possible technologies based upon this new force and related effects.

Order charges exist in Nature. They exist in at least two forms: either attached to matter or as orderons. When order charges are attached to matter, then in certain circumstances it would be possible to separate the order-charged matter from the order-neutral matter. The order-charged matter could then be collected, manipulated and processed in ways in which to use the order charges attached to that matter. All kinds of devices based upon these order charges could then be created from order-charged matter. The order charges could even be moved to other types of matter to facilitate its manipulation to create new types of materials and/or devices.

In order to produce order charges, one needs a source. Order charges are produced in several ways with various degrees of impurity or purity. These charges may be used directly or further separated and purified. One process would be to separate the order-neutral matter from the order-charged matter. This could be done by an order-charge separator. The separated order charge could then be collected prior to use, or in certain circumstances, used directly.

Several examples will be given because the apparatus may take different forms. As order charge is separated and/or purified, it becomes possible to develop further devices and/or separators, and so examples of these will also be given.

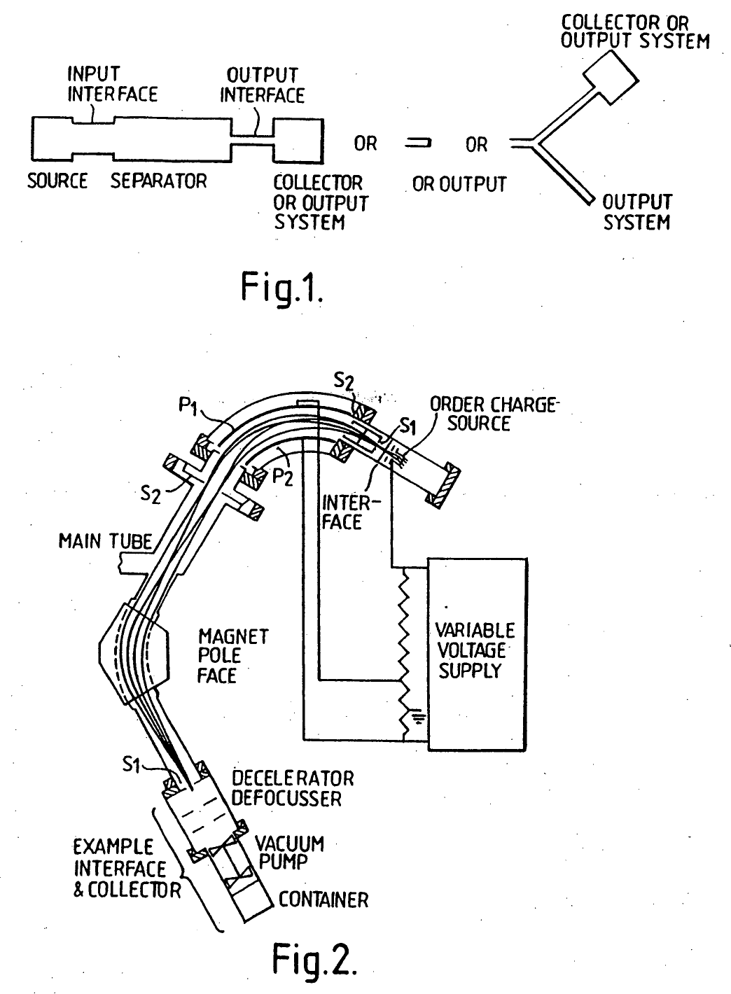

An example of the apparatus and processes may be given in parts, firstly for the source, secondly for the separator, and thirdly for the collector. We will then show how these combine to produce a system. In addition there may need to be interfaces between the source and separator, and/or between the separator and the collector, and/or output system. The apparatus is shown schematically in FIG. 1.

A. There are various types of source of order charge. Order charge can be produced in nuclear processes but only under certain circumstances. The alpha decay of certain nuclei can produce order-charged alpha particles. Order charges may also be attached to neutrons, protons or pions emitted by nuclei. Order charges exist inside nuclei, and under certain circumstances are emitted naturally, or they can be deliberately forced out of a nucleus. If a radioactive nucleus is order-neutral, then it may still emit an order-charged secondary hadron, at least some of the time. Alternatively, a nucleus can be forced to emit order-charged fragments by suitable processes, such as for example the collision of two nuclei in or as a consequence of a suitable accelerator device, or the collision of a particle with another hadron or nucleus, at suitable energies, usually above the threshold suitable to produce fragments some of which may be order-charged, typically being several tens of MeV per atomic mass unit or more.

More specific examples of these types of source are as follows:

1. A radioactive material which emits alpha-particles will produce some order-charged alpha-particles. This appears to be particularly the case for heavier nuclei, but any nucleus which emits order-charged alphas will do.

2. Certain rocks and crystalline materials contain radioactive inclusions, some of which can produce radioactive halos. These inclusions can produce alpha-particles or other radiation which carries the order charge. Such rocks and/or crystals could be processed, for example by cutting, and/or drilling, and/or pulverising, and/or grinding, and/or by some other method(s), and/or some combination of these, to extract the order-charged matter, for example by selecting order-rich regions.

3. A radioactive substance which emits some other kind of radiation, some of which may be order-charged.

4. A nuclear reactor produces alpha particles, some of which will carry the order charge. Some of the neutrons from a reactor may carry the order charge, as may some of the other particles from a reactor.

5. If a beam of nuclei is collided with target nuclei, or if a beam of elementary particles is collided with target nuclei, some of the fragments may be order-charged. Such interactions could be brought about with particle, nuclear, and/or heavy ion accelerator technology, and/or colliding beam technology. The fragments produced may or may not be mass and/or momentum and/or direction selected, and/or focused into a beam of fragments. Heavier nuclei may produce more order-charged fragments, but any nuclei which produce some order-charged fragments will do.

6. The sun is a source of order charge. The low fluxes of protons and alpha particles, and other particles, which come from the sun, are potential sources of order-charged matter.

7. The sun emits large numbers of orderons, which carry order charge, probably in the form of order-antiorder charge. However, orderons appear to be massless and seem only to couple weakly to order-neutral matter, probably by order van der Waals forces. Nevertheless, matter that has been exposed to sunlight could contain order charge and could be used as a source if then processed suitably.

One or more of these sources of order-charged matter are then the source.

B. Secondly, there are various types of separator. Separators work on various principles which divide into two main classes. There are those which separate the order charges indirectly as a result of the changes they produce in the matter to which they are attached, and there are those which specifically act upon the order charge itself, for example via order-charge fields. The former are referred to below as “type-0 separators” or “type-0 spectrometers”, or sometimes as primary separators. The latter, however may be considered to be secondary separators, because they require the existence of order charges and/or order fields to act upon the order charges to be separated. In other words, they will probably only be developed after order charges have been separated, probably by some other means, and/or order fields necessary for their function have been created. The latter are referred to below as “type-1, or “type-2/3, or “pure type-n (n=1, 2, or 3), spectrometers”.

Primary separators act upon the matter associated with the order charge and separate it from matter that is order neutral. Examples of methods for doing this are as follows:

1. An order-charged alpha particle or other order-charged matter will have a slightly different mass than that of the same order-neutral state of matter. Thus any device which separates matter into its different mass states could be used for the separation stage to separate order charges. For example, an order-charged alpha particle would have a mass approximately 0.1% to 1% different from an order-neutral alpha particle. A mass spectrometer could be used to separate these mass states, and the order-charged matter could then be collected.

2. There are numerous processes which are mass-sensitive or may otherwise be sensitive to order charge, such as various types of spectrometer, diffraction, resonance processes, kinematic processes, time of flight, range, diffusion, and even certain chemical reactions, which could be used to separate order-charged matter from order-neutral matter. Spectrometers with an electric and/or magnetic field together with some kind of velocity detector/selector and/or time-of-flight device can separate different mass states.

3. Order charge probably changes other properties of matter. For example it may well alter nuclear magnetic moments, which could be selected by a resonance or other process.

4. Furthermore, order-charged matter may have different energy and/or directional properties at the source, and these could be selected upon to enhance the concentration of order-charged matter. This is particularly the case for order-charged fragments produced in nuclear collisions, but it might also apply to certain radioactive sources. By selecting upon those states which carry the order charge it might be more easily concentrated in certain circumstances. Furthermore, this selection at source could be combined with a suitable separator.

Secondary separators require the creation of order-charge fields, which then act directly on the order-charged states and deflect them so that they are separated and/or concentrated. Secondary separators are so called because, although they may later prove to be the most effective, they cannot be constructed until some way has been found of isolating order charge and/or creating order/charge fields, for example by first separating order charge with a primary separator. Once order charge can be concentrated, it would become possible to create a simple order-charge spectrometer. For example, a concentration of order-charge would deflect other order-charged states, but not order-neutral states.

C. Thirdly, there are various possible types of output system and/or collector. The basic idea is that the system can either be run to supply order charge, for example to where it is directly required, or the order charge can be collected for subsequent distribution or use or application. The system could be built to act just as a source, or with a collector, or with both, which could be run alternatively, or even at the same time.

If the order charge is to be collected, then the type of collector depends upon the form of the order-charged matter, the type of separator used, and how much order charge one wishes to collect. The potential problem is that orderons can carry the order charge. Therefore, if too much order charge is accumulated in one place so as to create too high an order-charge potential, then it could simply be radiated away. In particular, the shape of gradient of order charge may be significant in determining the order field, so that by suitable control of the shape, the order field gradient can be limited and the risk and/or flux of discharge minimized. If too high an order charge concentration is a problem, then the collector has to be changed, either continuously or discretely, so as to allow for the charge collected not exceeding a certain concentration. Or alternatively, the matter has to be arranged so that a radiated orderon is captured on another nucleus, thereby order-ionizing it, so that the total amount of order charge in the collector is conserved, or at least the leakage is minimized.

If the source is producing alpha particles or some other form of particulate matter, then those particles or nuclear fragments, could be trapped by a collector, either on a plate, or in a bottle, or concentrated in a bottle via a pump, such as a vacuum pump. If necessary they could be electrically neutralized, i.e. alpha particles could receive electrons and become helium atoms. If the particles are collected on a plate, this could be in the form of a moving strip, which would prevent the build-up of too much order charge. The strip could move to a place where it was processed to remove the order-charged matter, for example by heating, the order charge could be collected and the strip returned to collect more order charge from the separator, all as a continuous process.

It may be necessary for there to be interfaces between the source and separator and/or separator and collector. The first we call the input interface, and the latter we call the output interface. The input interface, if necessary, is designed to bring as many of the source order-charged matter into the separator, at the right energies, at the right angles, at the right state of ionization, and so on, as is possible for that separator. The output interface is designed to guide the maximum output into the collector, and/or maximize the purity being collected, and/or some other design consideration. The output interface may or may not have a decelerator, and/or a defocuser, and/or a stopper. In some cases these interfaces may just be simple mechanical connections.

An output system would deliver the order charge more directly to where it was to be used. This could take the form of a beam of order charge, or some system of applying order charge to materials, or some system of supplying order charge to other apparatus where it may or may not be collected, used or otherwise processed or some combination of these. If order charge is to be applied to materials, this could be done directly inside the vacuum of the system, where the order charge may or may not be controlled, positioned, focused and so on by suitable slits, optics, accelerations and/or decelerations.

Alternatively the order charge could be conducted out of the vacuum system of the apparatus and applied to materials external to the system. One way to do this would be to make a beam of order charge, which could be used for other purposes too. For example, a very thin window would allow order charge to pass out of the vacuum system, especially if the order charge was first accelerated to sufficient energy or already had sufficient energy to traverse the thin window. Once an external beam had been produced, it could be further manipulated with slits, optics, focusing and/or bending devices, other accelerating or decelerating devices, and/or other equipment, so that the beam can be given the required properties and directed to the appropriate place or places in a suitable or desired way.

Such output systems could supply order charge in a continuous or intermittent way, and could be used instead of a collector, or alternatively with a collector, or in parallel with a collector.

It is now possible to give several examples of the invention, now that the various pieces of the order-charge separation system have been presented:

I. The first example is as shown in FIG. 2. In this example, the source consists of heavy nuclei emitting alpha particles. This could be as a radioactive source, or it could be from a nuclear reactor. In the former case, the alpha particles will already be ionized, but in the latter case they may take the form of helium atoms and so have to be ionized. Helium atoms are not easily ionized and a plasma ion source or similarly powerful ionizing source would be required.

Alpha particles from a radioactive source typically have energies of millions of electron volts, and fragments from a heavy ion accelerator could be even more energetic. Mass spectrometers can be built to work at these energies, but large magnets are required. Mass spectrometers which are designed to work at lower energies can be just as precise and efficient, if not more so and usually cost less. Therefore, if there was a way to slow the alphas, or nuclear fragments, before putting them into the mass spectrometer, then this could be both cheaper and simpler. However, high voltage deceleration technology would be expensive and it would tend to produce an expansion of phase space, which would require (stochastic) cooling to get the flux up. One solution is to use the finite range to slow the alpha particles (or fragments but it will work best with mono-energetic alphas from a particular source) and pass them through a precisely designed foil or metal plate specially shaped around the radioactive source, so that the alphas are almost stopped but emerge moving very slowly on the other side. A suitable high voltage accelerating and focusing field would then draw more of these alphas back into the mass spectrometer at the right energies. However, there will still be some spread in angles and kinetic energy, so that the mass spectrometer might have to be especially designed to handle the increased phase space. For this reason alternative types of spectrometer are considered below.

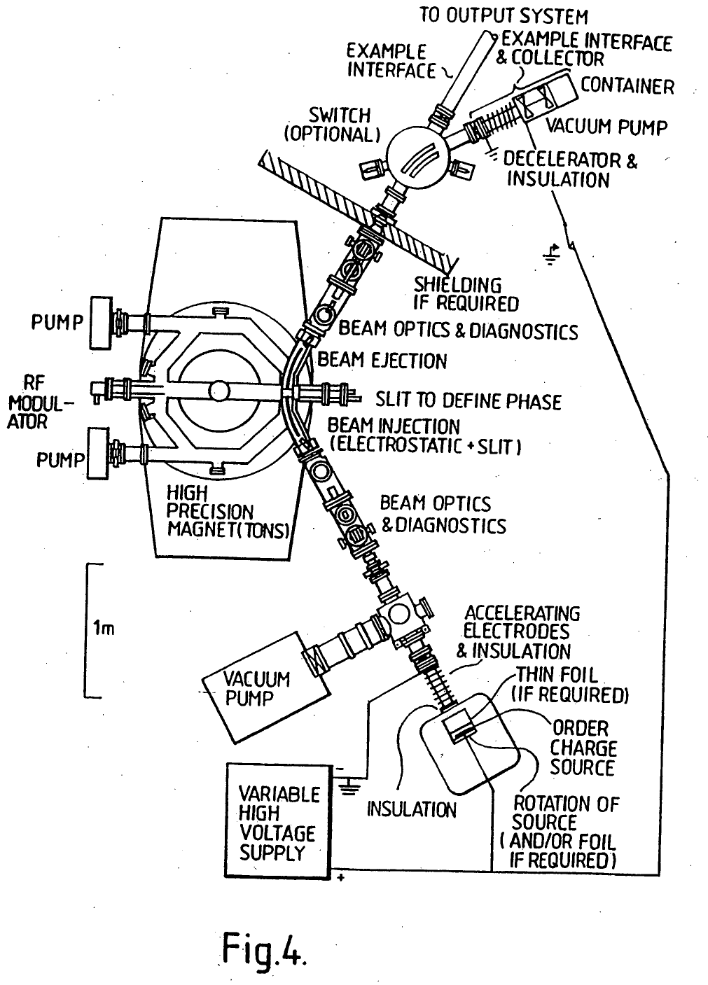

Electrically ionized alpha particles are then passed into a mass spectrometer, usually through a slit or system of slits, and often with suitable optics for guiding and focusing the flux. If the energies are thermal, or low, then they will have to be accelerated into the mass spectrometer. This could be done electrically as shown in FIG. 4. The mass spectrometer has specially shaped electric and magnetic fields which guide the alpha particles along suitable trajectories, and separate them according to their mass. Usually the system is designed to focus the image of the inlet slit onto an outlet slit. In this case, the mass of the alpha particles which traverse the system can be selected by adjusting the position of the exit slit with respect to the image of the input slit. By adjusting the slit to allow order-charged alpha particles to be transmitted by the system, and order-neutral alphas to be blocked, it is possible to separate order-charged alpha particles from the order-neutral ones. The alpha particles are then passed through the output interface, if required, and stopped, and/or collected, and/or otherwise delivered to the output system. For example they can be stopped on a plate which also can neutralize them, and which may or may not be heated so as to boil them off into a vacuum pump which pumps the order-charged helium atoms into a suitable bottle to contain them.

There are two problems with this example concerning the source of the alpha particles and the resolution. If the alphas are slowed in a foil, then, depending on its thickness, they are either thermalized or still have higher kinetic energy. For example, the range of the 5.486 MeV alphas from Americium-241 is 22 microns of aluminium. A foil thicker than this will thermalize the alphas, a foil thinner than this will allow them to pass through with some residual kinetic energy. If the foil is thick enough to thermalize them, then they will have picked up atomic electrons and will have to be re-ionized by a plasma ion source or similar, because helium is difficult to ionize. If the foil is thinner so that they escape in flight, then they will have a spread (possibly wide) in both angles and kinetic energies, which will result in reduced mass resolution for the spectrometer. Such a device measures the magnetic rigidity, which depends upon both the mass and the velocity, so that different mass and energy regions can overlap, thereby reducing the resolution.

The mass resolution actually required depends upon the mass difference between the mass of the normal alphas (αs) and the mass of the order-charged alphas-primes (α′s), the relative fluxes of αs and α′s, and upon the various backgrounds. If the spectrometer is sensitive to charge over mass (q/m) and one is working with singly charged alphas, then there are potentially two common backgrounds. The masses are:

| Ion | Mass | A/q | delta | MeV |
|---|---|---|---|---|
| ⁴He⁺ | 4.00207 | 4.00207 | — | — |
| ¹²C⁺⁺⁺ | 11.99840 | 3.99947 | −.00065 | −2.4 |
| ¹⁶O⁺⁺⁺⁺ | 15.992787 | 3.99820 | −.00097 | −3.6 |

Thus there are two backgrounds on the low-mass side of the main (order-neutral) alpha peak. (There may be others depending upon the impurities in the vacuum.) There are several factors which determine the mass-resolution required for this system. Two of these are the mass of the order-charged alpha particle and the ratio of numbers of α′ to α. If the mass of the α′ is less than the mass of the alpha, then it can also be confused with these two backgrounds and higher resolution is required, than if its mass is greater than. If the α′ mass is greater than the mass of the order-neutral alpha, then one does not need so much resolution to distinguish it from the backgrounds, but one still needs enough resolution to separate it from the tail of the main alpha peak. The ability to make this separation depends upon the difference in mass between the two types of alpha particle, and the relative numbers of αs and α′s. If the relative flux of the latter is too low, then the few genuine events could be lost in the background tail of the main peak or other backgrounds. Higher resolution can help to resolve these problems.

Thus the first example given here would work provided that the various circumstances did not conspire to require a higher resolution and/or background rejection than can be provided by the combined effects of the source, the decelerating system, the input slits and optics, and the mass spectrometer. If however, higher resolution is required, then it would be necessary to go to some higher resolution kind of system.

II. One of the highest resolution systems is the Penning trap. The mass measurement of an ion in a Penning trap is made by determining its cyclotron frequency in a precision magnetic field. Resolving powers of one million or more can be achieved.

A typical system would consist of an alpha source (e.g. radioactive source or nuclear reactor with suitable plasma ionization, or heavy ion fragmentation source), with suitable degrader or thermalizer where required (e.g. a thin foil of suitable thickness for a given alpha source, or the degradation can take place in the radioactive source if it has a finite thickness. This can be fine-tuned by the simple method of rotating the alpha source, and/or foil if there is one, so that only alphas that have traversed some of the material of the source and/or foil could enter the spectrometer), plus an ion beam buncher and cooler, the Penning mass spectrometer, and some kind of detector and/or collecting system. The ion buncher and cooler could also be of the Penning trap type. It could cool the alpha particles by collisions with a buffer gas. However, there could be problems with the alphas picking up electrons and becoming neutral helium, since helium binds electrons very strongly, so that they could then not be trapped. One solution to this is to use an ionized buffer gas, but this could introduce other backgrounds. Or one could use another inert gas. The alphas are cooled and trapped in the first trap, and then sent by special optics to the second trap, where the mass measurement is made.

There are a number of potential problems with such a system:

a. Such a Penning trap has many parameters, typically about 100 to 200 or more, which have to be optimized. As a result such a precise instrument would take weeks to set up initially. Once set up, however, it might well run reliably, and so these set-up difficulties might be acceptable.

b. The trap measures the average mass of a number of alphas, so that if one has one α′ with 9 order-neutral alphas in a bunch, then one would see the mass-shift as a significant proportion of the total mass difference. However, if there were more alphas in a bunch, say one thousand, then the shift in mass for one α′ to 999 as would be correspondingly smaller, and it might not be possible to detect the occasional α′ at all easily. This would tend to reduce the useful bunch size.

c. Typically, the mass is determined in one of two ways. If there are enough ions in the trap, one can determine the cyclotron frequency from that of the image charge. However, if there are fewer ions, then one has to eject them and determine the frequency with some kind of time-of-flight system or other detector. In the former case, it might be difficult to detect the odd α′ amongst thousands of normal alphas, as in point (b) above, and in the latter case, one might be able to detect the occasional α′, but there would still be problems actually separating that α′ from the other more normal alphas because all the ions first have to go to the detector to determine whether or not such an α′ is in the present bunch. Only after the bunch has arrived at the detector could the decision be taken to try to separate that bunch, which would normally be too late. There would then still be the problem of separating the α′ from the others in the bunch. Small bunch sizes would also mean a small flux through the system. Of course, the system might be operated on individual alphas and α′s, but then the flux would be very low.

d. In fact, whilst such a device might be used quite successfully to determine the mass of the α′, there would be problems separating the α′s from the normal alphas, because their trajectories are approximately the same since they are all in the same bunch. If there was some way of detecting the presence of an α′, then it might be possible to eject that bunch along a different trajectory, no doubt more easily in the image current detection method, but then one would not have pure α′s, but a mixture of order-charged and order-neutral alphas. If one was to feed the alphas through a chain of such and/or other separators, one might be able to produce a reasonably pure sample of order-charged alphas, but it seems unlikely that such a system would be particularly satisfactory from a number of points of view including cost, efficiency and ease of setting-up and operation.

III. What one needs is a type of spectrometer in which the separation takes place more cleanly. One possibility might be a time-of-flight spectrometer. If one has a monochromatic source of alphas, such as americium-241, and the alphas are guided through the vacuum system of the spectrometer (without degrading their energy, as with a foil), then one still has to allow for background alphas from the source which do not have the same energy as the main peak. One way to do this is with a combination of magnetic spectrometer and time-of-flight. But time-of-flight requires start and stop signals. X-rays from the source might provide the start signal, but this would be an unusual technology and it is not clear how precise the time resolution would be. Furthermore, the stop signal would also come from a detector in the vacuum system which would absorb the alpha. This might be good enough to measure the mass of the α′, but it would require some ingenuity to separate order-charged from order-neutral alphas and to collect them. Some of these problems could be eliminated by accelerating the alphas to several GeV and using the techniques of high energy physics.

IV. So what one needs is a high resolution spectrometer, which may have two separate separation processes, which causes the order-charged alphas to be physically separated from the order-neutral alphas, in such a way that they can be directed towards a suitable collection device. In this way, despite the different incident angles and energies of the alphas, the order-charged mass state can be cleanly separated from the normal mass-state and from any backgrounds present in the system, and then directed to a collector where the order-charged alphas can be collected for later removal from the system and storage, or whatever use is required.

One such spectrometer which allows for such precise separation is the Smith spectrometer. The Smith-type mass-spectrometer makes use of a combined system of magnetic fields, slits, other optics, and a radio-frequency system, to separate different mass and energy states.¹ The system can be designed and tuned to operate over a range of masses and of mass-resolutions up to a resolution of 10⁵ or more.
¹ L. G. Smith, Phys. Rev. C 4, 22-31 (1971), and references therein.

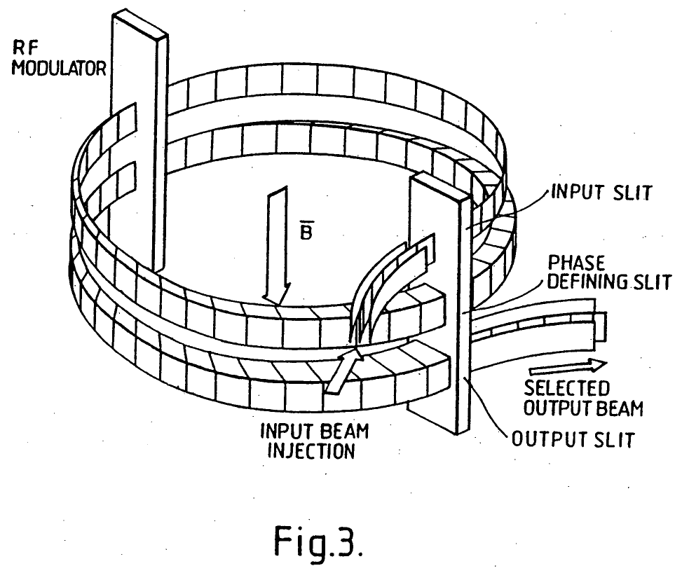

FIG. 3 shows the principle of operation of a Smith-type spectrometer. The beam of ionized alphas is injected into the system through a system of suitable deceleration, acceleration, optics and slits. Once inside the spectrometer, the beam of alphas orbits with a radius of R=SQRT(2mT)/qB, where m is the mass of the ion, q its charge, T its kinetic energy and B the magnetic field in the spectrometer. Thus different mass and kinetic energy states can have the same radius of orbit. These can be further separated by means of their cyclotron frequency.

The cyclotron frequency of such a particle is given by f_{c}=qB/m. If there are two particles 1 and 2 with masses m₁ and m₂, then they are linked by the relationship: m₁f₁=m₂f₂. An RF signal is applied to the RF modulator in such a way that the beam is accelerated by a certain amount on the first crossing, and decelerated by an equal amount on the second crossing, so that the net energy gain is zero. One thus has two mass resolution effects, one which depends upon kinetic energy and the other which does not. This enables one to determine the mass independent of the spread of kinetic energy and angles at the input. Typically the RF frequency is run at f=(n+1/2)×f_{c}, where n is an integer, and the resolving power is given by 2πn(dₘ/w) where w is the common width of the inlet, modulator and exit slits, and dₘ is the modulation amplitude of the diameter. If the RF frequency is scanned, one gets peaks corresponding to the different mass states.

The beauty of such a device is that it can be designed to optimize the separation of order-charged alphas from order-neutral and/or other back-grounds, despite a spread in input angles and kinetic energies, to optimize the transmission of the system so as to trap α′ efficiently, and it runs in a continuous mode, so that one can pass a steady stream of alphas and α′s into the system, and separate out cleanly a beam of α′s which can be guided to a suitable collector.

The Smith spectrometer can of course be used with other types of matter, other than alphas, in order to separate order-charged states from order-neutral states.

A Smith-type spectrometer can be designed to be used with different types of source, such as an alpha source, a heavy-ion accelerator source of alphas of other types of matter and/or nuclear fragments, a reactor, or other alpha or helium source, or even commercially available helium gas, or other sources of order-carrying matter. The source is likely to be chosen for reasons of cost. Typically one would want the highest flux of order-charged matter through the system for the least cost. If a radioactive alpha source is used, then one is likely to have to have a foil to slow the alphas down, or to turn the source at an angle so that the alphas are degraded in the material of the source. Or one could thermalize the alphas, but then they would have to be re-ionized by a suitable plasma or other ion source. Alphas from a heavy-ion source, from a reactor or from another source or helium gas source would have to be first ionized by a suitable plasma or other ion source. Other states of matter from a heavy-ion source would require to be ionized if previously they had been thermalized.

It is straightforward to connect a plasma ion source and feed helium gas into the system. Other sources of order-charged matter such as heavy ion sources, nuclear fragments, or other source of order-charged matter or radiation of any kind could be used. If the system is to be used with several input sources, then it would be convenient to have a switch-yard to facilitate change from one source to another.

These slowed-down ionized alphas or other states of matter would then be focused and accelerated into the Smith-type spectrometer using suitable combinations of acceleration technology (high voltages) slits and focusing devices. All would have to be in a vacuum because alphas or other states of matter have such a short range. Once a beam of order-carrying states had been formed, it would be guided into the Smith spectrometer, where the mass separation processes could be adjusted to separate out order-charged mass states, as already explained, so that they could be guided to a suitable deceleration and/or collection system, or alternatively used as a source of order-charged matter which could be applied to materials within the vacuum system, and/or turned into a beam of order-charged matter, and/or passed into further stages of acceleration, and/or passed through a thin window so as to form an external source and/or beam, and or used in a treatment plant and/or directly as a source of order charge.

We refer to these examples (I to IV), which separate order-charge from order-neutral states, (but without further separation of the order-charge states, e.g. because they do not deploy order-charge in the active separator) as “type-0 spectrometers” or “type-0 separators”.

A Smith-type spectrometer or another other type of spectrometer or separator used in order-charge separators, are normally designed to achieve a given mass resolution. When one is used as of an order-charge separation system, then the purity of the separated sample, and the flux through the system are more important considerations, although they may depend upon the mass resolution, possibly in conflicting ways. One solution to this would be to design the system with variable resolution and/or other variable parameters, so that it can be run in different modes, for example to maximise purity or to maximize the yield, or some combination of these and/or other factors. One way to do this would be with variable slits. If the various slits and/or apertures in the system are driven by electric motors or other means, then they could be adjusted to provide the performance or mode required.

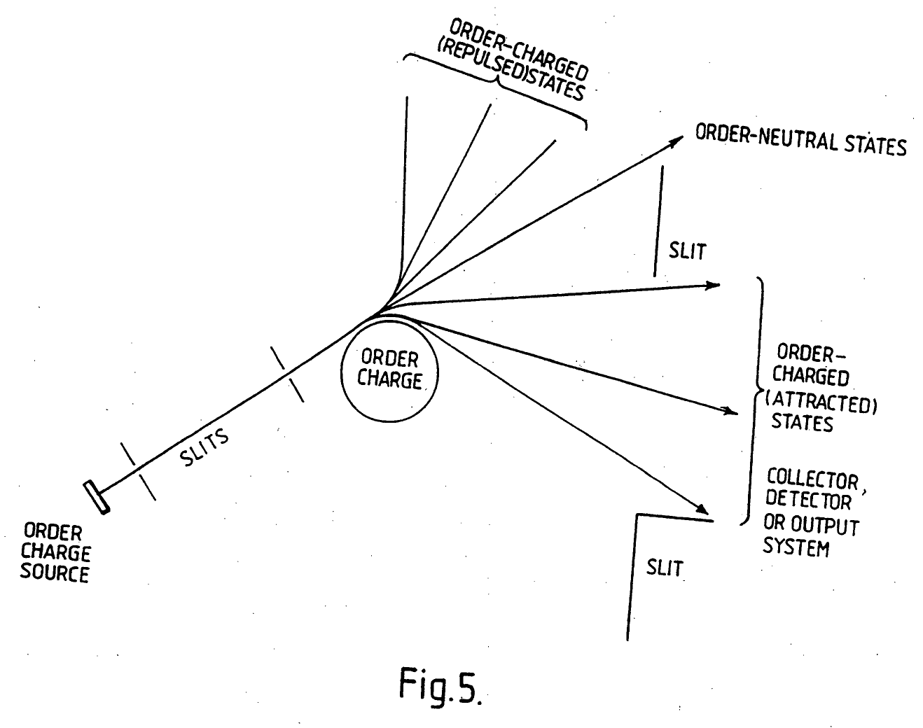

V. Once order charge has been separated, it becomes possible to build an order-charge spectrometer which uses previously-separated order charge, or an order field, to separate order-charge from other matter, and further separate order-charge types. FIG. 5 shows a schematic of an order-charge spectrometer, or secondary spectrometer, as we call it. (Different forms of this are referred to below as “type-1 spectrometers”, “type-2/3 spectrometers”, and “pure type-n spectrometers” where n=1, 2, or 3.) In this order-charge spectrometer, a suitably-shaped amount of order charge is used to deflect order-charged states, from order neutral states. Order-neutral states do not sense the field, unless it is via short-range order van der Waals forces, and so passes (almost) straight through the apparatus. On the other hand, order-charged states sense the field of the order charge and are deflected. These deflected states can then be separated from the order-neutral states by systems of slits and/or barriers, or other separators, and then collected, stored, or otherwise used in subsequent stages and/or elsewhere. Note that the range of the order force is only known to extend to microns, at present. If the range of this force is found to be long-range, i.e. extending to infinity, then one could design a large scale separating device. However, if the range is limited in some way, then some small-scale precision engineering would be required.

There are two types of deflection in the order-charge field: like charges are repulsed, and different charges are attracted. There are three different types of order charge, which we can call type-1, type-2 and type-3 for convenience. (Red, green and blue are alternative names for these three charges.) If one type is repulsed, then the other two types will be attracted, and so the repulsed charges will always be purer than the attracted charges. This then provides a mechanism for separating order-charge states into their subsequent three charge states.

Firstly one has to separate some order charge with a primary spectrometer. One can then use this separated charge to construct a secondary spectrometer. The distribution of charge types (type-1, -2 or -3; red, green or blue) of the three charge states, will probably be random, and will therefore be roughly equal amounts of each different charge-type. However, it is unlikely that there will be exactly equal amounts of charge, and there will always tend to be one charge-type which predominates. This is especially true for small order-charge samples. Thus, one can separate the same charge state by using the repulsed order-charge, and one can concentrate it with a cascade of order-charge spectrometers. Alternatively, it can be concentrated by collecting the repulsed state, and then using that to make the next order-charge pole, which can then be put back into the original order-charge spectrometer, or used as the pole of the second order-charge spectrometer. Alternatively, one can repeatedly pass it through one spectrometer, taking the repulsed fraction each time, to purify it. Charge that is progressively repulsed by a chain of such spectrometers, or by repeated separation, will become progressively purer in that one charge state.

Likewise, the attracted states will become repeatedly pure in the other two charges. One can then make a tertiary spectrometer using these other two charges as the spectrometer pole, and then repeatedly passing the two charge states (i.e. attracted from the secondary spectrometers) through and collecting the repulsed state. Repeatedly doing this, either through the same spectrometer, or through a cascade of spectrometers, or by using the output to create the pole of the next spectrometer, and so on (e.g. in a similar way used to separate type-1 charge), will further enhance the separation of the remaining two charges.

VI. Once these three charge states have been separated, then it would start to become possible to set up a complete system to separate the three charge states. That is to say, there is a sequence of step which has to be followed: firstly, one separates and concentrates order-charge states from order-neutral states. Then one uses the separated charges, especially fluctuations in the same, to separate the individual charge states. Once pure samples of the individual charges states have been separated, then it would be possible to set up a production system to separate each of the three charge states.

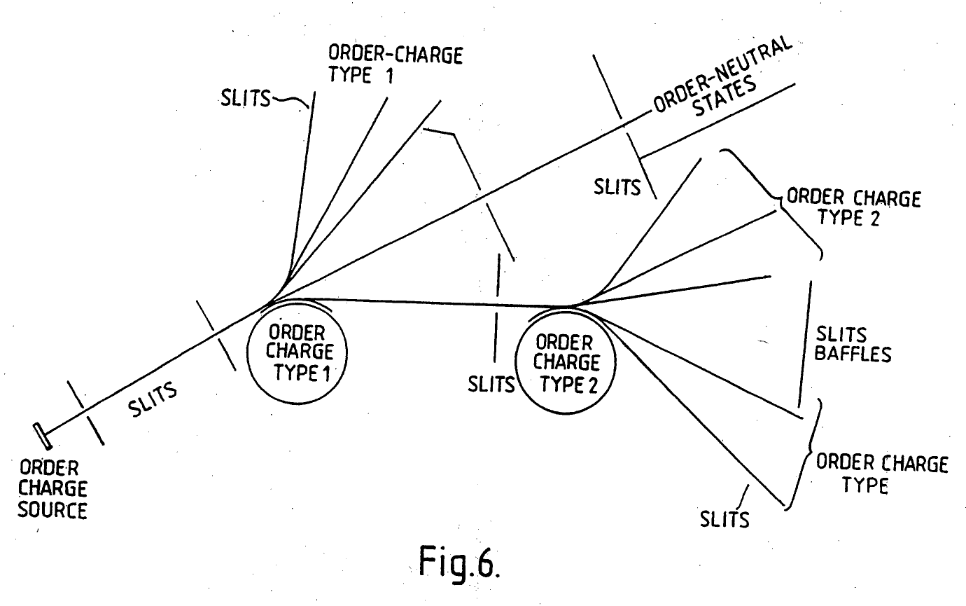

FIG. 6 shows an example of a complete order-charge separation system right down to the individual charges. (The same comments about the dimensions of FIG. 5 apply here.) It requires the pre-existent separation of two order charges (say type 1 and type 2) and their fabrication into the active elements of two pure-order-charge spectrometers in tandem (in the figure these are pure type-1 and pure type-2 spectrometers, although any permutation of the charge types is possible). Then the first spectrometer (type 1) will repulse type 1 charge and separate it, whilst order-neutral states will pass right through. Subsequently, the second spectrometer (type 2) repulses type-2 charges and separates them from type-3. A subsequent (third) type-3 separator can be used to effectuate further purification of the type-3 charge. If the three final charge states are not pure enough, then a cascade of such devices will produce purer charge, or it can be recycled for further purification.

VII. What one sees is that as the technology is worked with and as order charge is separated in ever purer samples, it becomes possible to design more precise and effective separation systems. The first level of this invention involves the separation of raw order charge (or mixed charge-types); the second in splitting this charge into ever purer samples of the three charge types; at which point it becomes much easier to separate order-charge and non-order-charge states and to split the three order-charge types directly.

1. An order charge separation apparatus comprising, in series, a source of order charge, means for selection on the basis of order charge, and a collection means for order charge.

2. An order charge separation apparatus as claimed in claim 1, wherein the selection means acts in ways other than by the ordering charge.

3. An order charge separation apparatus as claimed in claim 1, in which the selection means is based upon the order charge.

4. An order charge separation apparatus as claimed in claim 3 in which the source is an alpha emitter.

5. An order charge separation apparatus as claimed in claim 1 wherein the source of order charge consists of free order charge which has subsequently been attached to matter.

6. An order charge separation apparatus as claimed claim 5 in which the free order charge is attached by exposure to sunlight.

7. An order charge separation apparatus as claimed in claim 1, wherein the separator is an order-charge separator where the active element is one of order-charge itself, an order-charge field, so that order-charge states passing through this order-charge spectrometer tend to be deflected by the order-charge or order field respectively whilst order-neutral states are not so deflected and so continue in their normal trajectory.

8. An order charge separation apparatus as claimed in claim 1, wherein at least one of a restriction, limitation, cut, slit aperture, barrier and optics is introduced to separate order-charge states from order-neutral states.

9. An order charge separation apparatus as claimed in claim 8, wherein the restriction, limitation, cut, slit aperture, barrier and optics respectively are adjustable.

10. An order charge separation apparatus as claimed in claim 1, wherein a triggerable device is engaged to separate a small group of order charged particles and/or states respectively from order-neutral states.

11. An order charge separation apparatus as claimed in claim 10 in which the triggerable device includes at lease one of a mobile shutter, a pulsed field, an electric field, a magnetic field, a kicker magnet, a mechanical intervention device, an electronic device, an order-charged device, a time-of-flight system, a pulse height technique and an energy loss system.

12. An order charge separation apparatus as claimed in claim 1, further comprising an output system which provides one of an order-charge source, and order-charge beam, which can be used as a beam of order charge.

13. An order charge separation apparatus as claimed in claim 12, wherein the output system is in the form of an external beam arranged to pass through is a thin window thereby to allow the order-charged matter to exit the system.

14. An order charge separation apparatus as claimed in claim 1, comprising means operating on the separated order charge for generating an order field and means employing the order field to further separate order-charged states from order-neutral states.

15. An order charge separation apparatus as claimed in claim 1, wherein previously separated order charge is shaped and used as a deflecting mechanism in an order charge spectrometer.

16. An order charge separation apparatus comprising an order charge output system including the order charge collection means, thereby to effectuate order-charge type separation.
